(19) United States
(12) Patent Application Publication
(10) Pub. No.: US 2026/0268258 A1
(43) Pub. Date: Sep. 10, 2026

(54) SYSTEMS AND METHODS RELATED TO STORMWATER BMP MANAGEMENT

(71) Applicant: metaBMP LLC, DOUSMAN, WI (US)

(72) Inventors: NATHAN W. MINOR, DOUSMAN, WI (US); DANIEL P. HABLE, FOOTHILL RANCH, CA (US); TYLER A. SMITH, MONTICELLO, WI (US)

(21) Appl. No.: 19/549,642

(22) Filed: Feb. 25, 2026

Related U.S. Application Data
(60) Provisional application No. 63/762,756, filed on Feb. 25, 2025.

(51) Int. Cl. G06Q 10/0637; G06Q 50/06

(52) U.S. Cl. CPC G06Q 10/0637; G06Q 50/06

(57) ABSTRACT

Embodiments of systems and methods for stormwater BMP management are disclosed. In particular, systems and methods according to the present invention comprise a program connected to a database and accessible over the internet, such database populated with BMP-related information for a plurality of sites. The program may be accessed over a computer network by a plurality of users to facilitate efficient and collaborative information sharing and updating for BMP’s on a site specific level, local municipality level, or even statewide level.

### BACKGROUND OF THE INVENTION

In the field of stormwater management, best management practices (BMP’s) are strategies and control areas that are designed to minimize the risk of pollution, flooding, and/or erosion caused by runoff. BMP’s are necessary to prevent local environmental problems. For example, erosion caused by land disturbances and/ or dangerous chemicals, whether housed on site or naturally occurring, may be just one rain or snowstorm away from being swept into nearby water systems, which could potentially cause an ecological disaster. BMP’s help alleviate these environmental risks. BMP’s are advantageous in that they promote the natural movement of water, instead of allowing runoff to flow into streets and storm drains, they can blend in with the environment and infrastructure, they can be infrastructure themselves (such as a permeable parking lot), they can provide aesthetic benefits, they can reduce the amount of pollutants entering water systems, and they can improve water quality.

There are several different types of BMP’s, from strategic planning practices to structural practices. Some strategic practices include controlling stabilization practices, such as mulching and hydroseeding, installing downspouts, diversion channels, and slope drains on steep hills, perimeter controls on construction sites to prevent pollution from being inadvertently transferred offsite, and pollution prevention practices such as spill prevention and response procedures.

Beyond strategic planning, BMP’s can also have physical, structural components. For example, Erosion and sediment control BMP’s are designed to minimize soil loss and prevent sediment-laden water from leaving construction sites. This type of BMP can be further broken down into point and linear BMP’s. Linear BMP’s typically have narrow, more linear shapes that run adjacent to stream channels and serve to filter or divert runoff. Further, linear BMP’s may have ancillary benefits such as shading for streams, wildlife habitats, and aesthetic value to the land. Structural examples of linear BMP’s include grassed swales, infiltration trenches, vegetated filter strips, silt fences, straw wattles, and check dams.

Point BMP’s, on the other hand, are designed to capture runoff and/or control erosion and sediment at specific areas. These areas may be used for any combination of detention, infiltration, evaporation, settling, and transformation to manage runoff flow and remove pollutants. Structural examples of point BMP’s include rain gardens and barrels, cisterns, constructed wetlands, infiltration basins, wet ponds, dry ponds, bioretention, retention basins, and sand filters.

BMP’s are usually installed during construction, when there is a greater risk of air and water pollution, and therefore standards have been set by local and state governments regarding BMP construction and management. However, the risks of air and water pollution do not end once construction ends and BMP’s generally remain on the land well after construction has ceased. Therefore, to remain effective at the tasks of removing pollutants and minimizing the risks of flooding and erosion, BMP’s must be inspected and/or repaired periodically.

However, after construction has ended and contractors have left the premises, the upkeep of these BMP’s often falls to the landowner, who may be ignorant of BMP’s purpose, requirements, or even location or existence in general. Further, one premises may have multiple BMP’s, where each BMP is of a different variety and location, leading to different requirements and maintenance schedules. Therefore, efficient and centralized systems and methods for tracking various aspects related to BMP’s are sought.

### SUMMARY OF THE INVENTION

Embodiments of systems and methods according to the present invention relate generally to BMP management and maintenance. Specifically, systems and methods are disclosed to track the location and all known data (creation, maintenance dates/times, types, etc.) of BMP’s in an easy to understand, user-friendly system. The system may take the form of an internet-accessed webpage and/or a downloadable application. Further, the system includes safeguards such as account and password creation and two-factor authentication techniques. The system is operated and maintained by a custodian, who oversees the system all information collected on it, and accounts connected to it.

### BRIEF DESCRIPTION OF THE DRAWINGS

FIG. 1 is a block diagram of a stormwater BMP management system according to the present invention.

FIG. 2 is a block diagram of a database utilized in the management system of FIG. 1.

FIG. 3 is a front view of a program account login screen according to the present invention.

FIG. 4 is a block diagram of different clients accessing the computer network according to the present invention.

FIG. 5 is a front view of a program homepage according to the present invention.

FIG. 6 is a front view of a program site-specific page according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

Stormwater best management practices (BMP’s), also known as stormwater control measures, generally refer to a collection of management solutions for managing the quantity and quality of water that collects and/or runs off land, both during wet and dry weather. BMP’s can comprise management practices and programs, such as mulching and hydroseeding, but BMP’s can also refer to physical structures such as retention ponds, wetlands, and trenches. Most BMP’s, both structural and strategic, are implemented during on-site construction, such as building or other structural construction, and many localities include strict rules requiring BMP’s to be implemented and maintained during construction. However, once construction has ceased, structural BMP’s don’t simply go away. Instead, many BMP’s are left on site to continue their jobs of environmental stabilization, erosion and sediment control, and air and water pollution management. These maintenance of these BMP’s are left up to the site owner, many of whom don’t understand what BMP’s are, let alone how to provide proper upkeep and maintenance. Businesses exist to do the inspections and maintenance for them, but often the required information is not properly tracked or stored and different competing businesses may not share information with each other. The present invention includes various embodiments of systems and methods for efficiently tracking and storing such BMP information in a centralized system, accessible by multiple parties to promote collaboration.

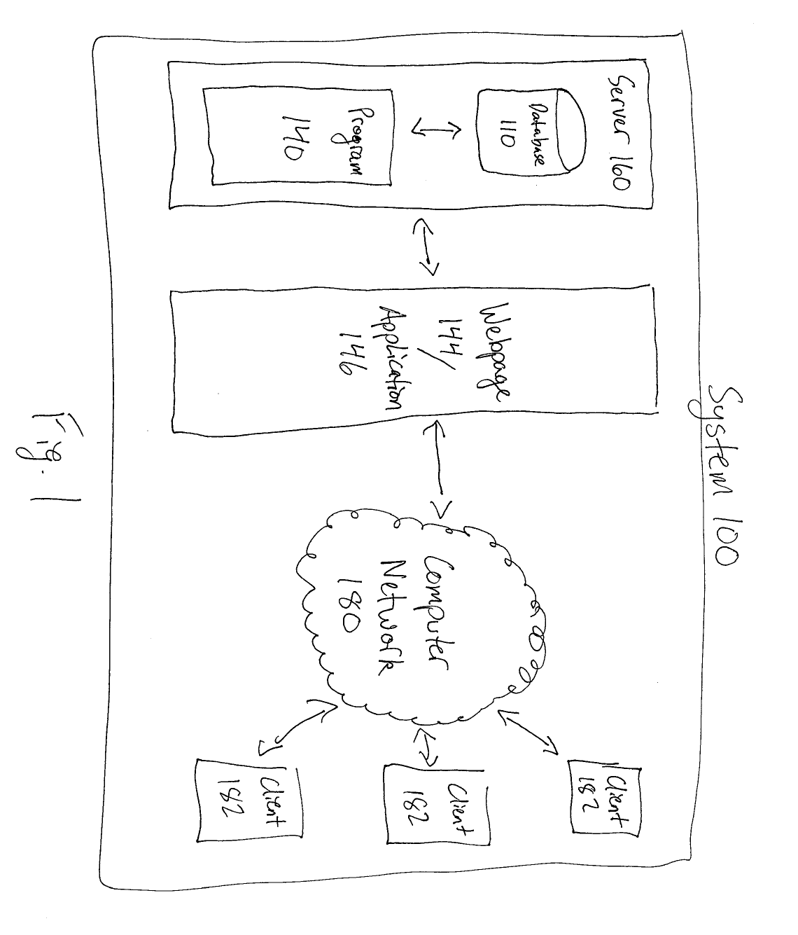

Turning now to the figures, systems and methods according to the present invention may be seen. Generally, as seen in FIG. 1, embodiments of a system 100 according to the present invention comprise a database 110 in wired or wireless communication with a website/program 140 to be accessed over a computer network 180 by one or more clients 182 through a webpage 144 and/or application 146. The database 110 and program 140 code are preferably stored and/or maintained in the same housing, such as a single server 160 on a storage rack, which is preferably owned and operated by a custodian on a site owned by the custodian, such as an office building or storage unit. However, separate housings for the database 110 and program 140 are also contemplated, such as separate servers 160, which may be stored and/or operated out of the same or separate physical locations or sites. The storage may also be remote, such as a cloud storage system hosted and managed by a third party. The accessibility of the program by multiple clients 182 allows for unprecedented collaboration in exchanging and sharing BMP-related information 114 regarding a specific location or even regarding whole areas in general.

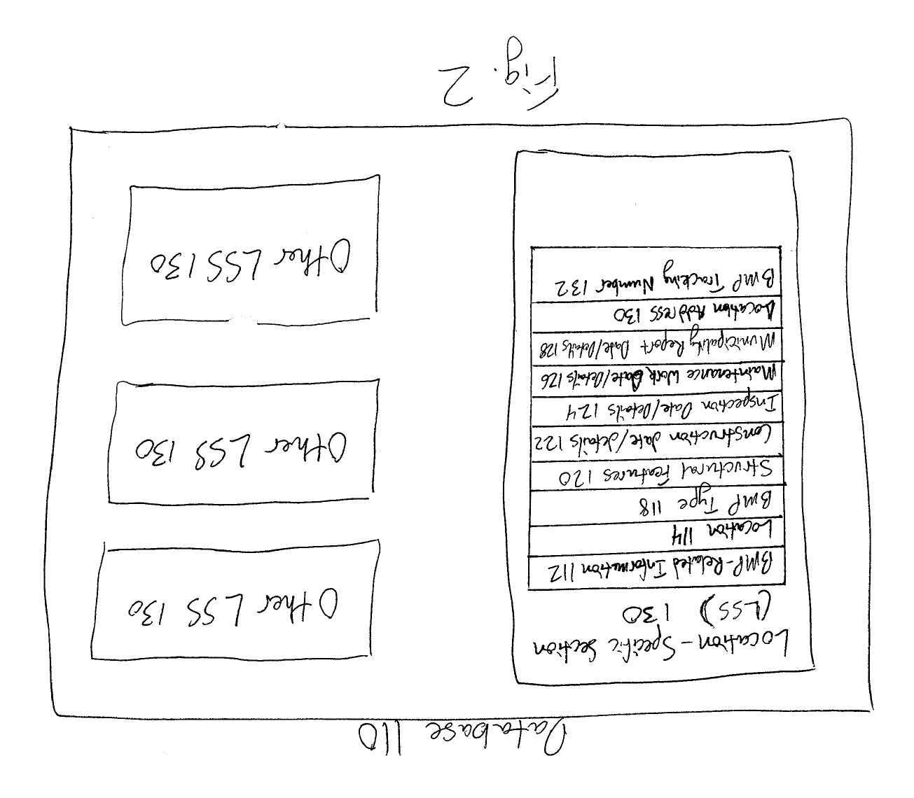

The database 110 is most preferably digital, not having a physical embodiment unless printed or otherwise physically embodied. Rather, the database 110 preferably exists on, and is accessible through, the computer network 180. As seen in FIG. 2, one database 110 is preferably used to store all BMP-related information 114 in connection with the present invention, however that database 110 may be preferably partitioned into separate location specific sections 112 related to each location having BMP information uploaded and/or input into the database 110. The location-pecific sections 110 preferably comprises BMP-related information 114, such as particular location 116 for each BMP on a site, type 118 of BMP, structural features 120 of the BMP, the date and details related to the construction 122 of the BMP, any dates and details related to inspections 124 done on the past or planned for the future, the dates and/or details related to any maintenance work performed or planned for the future 126, the address 130 associated with the BMP site, a BMP tracking page number 132 associated with each BMP at the site, the date and time any municipality report is filled out along with who filled the report out 128, and/or any specific information that may be required to know about the site (e.g. geographic, ecological, historical, etc.).

Such information is often required to be submitted to local authorities and governments on municipality reports submitted by site owners and is generally public record. Therefore, a simple request (with or without a fee, depending on the local government rules) may be enough to receive information related to BMP’s at any given site and that information may be used to populate the database 110. However, many localities have historically not strictly enforced rules requiring BMP information be tracked or updated, so this information may be outdated or flat out missing/unavailable. Further, the information required by municipality reports, as well as the layout of the reports themselves, varies by each municipality. Therefore, such information in publicly accessible areas is often lacking. Alternatively, the required information 114 may also be obtained directly from a site owner, especially if they have not updated their BMP information with the relevant authorities, and/or input directly to the database 110 by a worker as BMP inspection and/or maintenance is being conducted. The point is to build a database 110 of such BMP-related information that may be accessed and/or updated as more information becomes available.

Additional BMP-related information 114 that could also be stored in the database 110 and viewed and/or edited through the program 140 could include full documents, such as full municipality reports, construction reports, or other such documents. For example, full construction reports detailing the exact makeup, location, construction steps, etc. used in constructing all BMP’s on a given location may be uploaded to the database 110, either in picture form (as in a png or tiff file), pdf form, or in other file forms such as doc, docx, pages, etc. Such uploads may preferably be editable, such as by allowing a user to drop pins on the document itself on important information, such as locations of BMP’s or other erosion control measures that need to be inspected. The program 140 may further include functionality to automatically scan such documents and pull relevant information to populate the database 110. Users are preferably even able to upload manipulable construction documents, such as autoCAD files, to the database 110 and such documents may be viewable and clickable on the program 140 to see the blueprints or models for the physical structures that may need inspecting.

The database 110 may also preferably be populated with other information beyond BMP-related information 114 for any given sites. For example, erosion control measures (“EC’s”), such as vegetation planting sites, mulching, silt fences, sediment basins, riprap, earth walls, reforestation, and anchoring devices, may also be categorically logged and archived for later viewing through the program 140. In some instances, EC’s may be the first information uploaded or logged on the database 110, then BMP-related information 114 may be added throughout the construction process to streamline the transition from construction management to post construction management. In the present specification, all descriptions related to BMP’s may also refer to EC’s as well.

That database 110, including all location specific sections 112, is linked to a BMP-management program 140, which facilitates access to the database 110 through one or more clients 182. Clients 182 may be any device that is capable of accessing the computer network 180, such as personal computer or handheld smart device. Embodiments of the program 140 according to the present invention preferably display the BMP-related information 114 on an internet browser-accessible webpage 144, also hosted and/or stored on the server 160 by the custodian. However, alternate embodiments of the program 140 are also contemplated, such as an application 146 on a personal computer or a smart device. Such embodiments are preferably stored directly in the non-volatile read-only memory (ROM) of each client 182. Whichever embodiment of the program 140 is used, the program 140 is most preferably capable of accessing and storing data in the random-access memory (RAM) of the client 182 as well, to facilitate processes within the program 140 as described below.

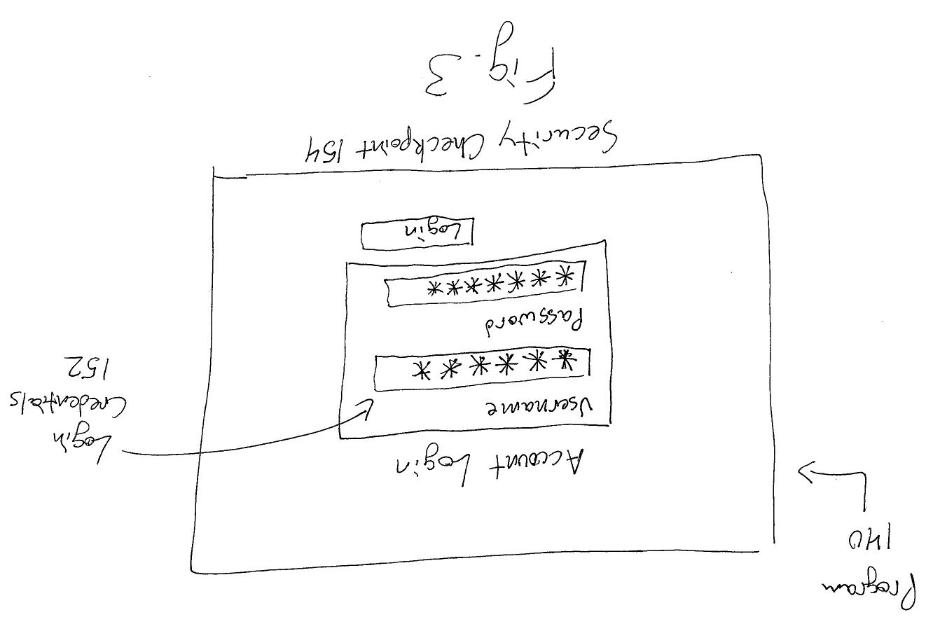

As seen in FIGS. 3–6, the program 140 most preferably comprises a navigable and/or manipulatable graphic user interface (GUI) 142 through which a user (a site owner, a government employee, a custodian, etc.) can access and/or manipulate data stored on the database 110, such as the BMP-related information 114. To access the program 140 through the webpage 144 or application 146, an account 150 linked to certain unique login credentials 152 is preferably required. That is, when attempting to access the webpage 144 or application 146, a user is first prompted to enter login credentials 152 at a security checkpoint 154, such as their email address and password, associated with their account 150. Failure to enter these credentials bars the users access to the webpage 144 and/or application 146, and thus to the program 140 and database 110 as well.

Accounts 150 may preferably be created through the program 140 by manipulating the GUI 142 to a new account creation page. As seen in FIG. 3, a user may preferably enter a username and their preferred email to associate with a new account 150 and the program 140 will preferably review a list of known accounts 150 for any that already use that email. If no known accounts 150 using that email exist, the user is preferably prompted to input a password to associate with that account and the account may be created. The login credentials 152 preferably further include password requirements, such as length, characters, spacing, and/or numbers being required to be present and/or required not to be present. Additionally or alternatively, the security checkpoint 154 preferably comprises at least one additional security access point beyond the login credentials 152, such as a biometrics login (e.g. fingerprint) or two factor authentication (e.g. security questions, one-time codes sent by text, email, or phone, etc.). Additionally or alternatively, a user may create an account 150 by contacting the custodian and providing their preferred login credentials 152, which the custodian then uses to create the account 150 through the program 140. The custodian may even operate the system 100 on a subscription basis, wherein account holders pay routinely (e.g. monthly, quarterly, yearly, etc.) for access to the system 100.

Most preferably, accounts 150 on the program 140 are limited in their access to the database 110, specifically to the BMP-related information 114 that pertains to the needs of the user at the time. Limitations are preferably set and/or manipulated by an administrative account maintained by the custodian. For example, if the user is a site owner, their account 150 preferably only has access to BMP-related information 114 pertaining to BMP’s that are located on their site. Alternatively, if the user is a government employee, their account 150 may preferably be able to access BMP-related information 114 on a larger scale, such as in their municipality if they are a local government employee or even on a state-wide level if they are a state government employee. Further, if the user is the custodian, or an agent or employee of the custodian, their account 150 may preferably be able to access all of the BMP-related information for management purposes. Other types of accounts 150 beyond these, with varying level of access, may also be created and/or supported by the program 140, including contractor and/or construction company accounts, as non-limiting examples. Additionally, certain users may preferably grant access to information they control and/or have access to to other users. For example, when a site owner hires a contractor to inspect and/or maintain BMP’s on their site, they may preferably grant the contractor temporary or even permanent access to the BMP-related information 114 pertaining to the BMP’s that are located on their site. This process facilitates efficient transfer of information between the parties and allows each party to view and possibly contribute to updating that information 114 if necessary.

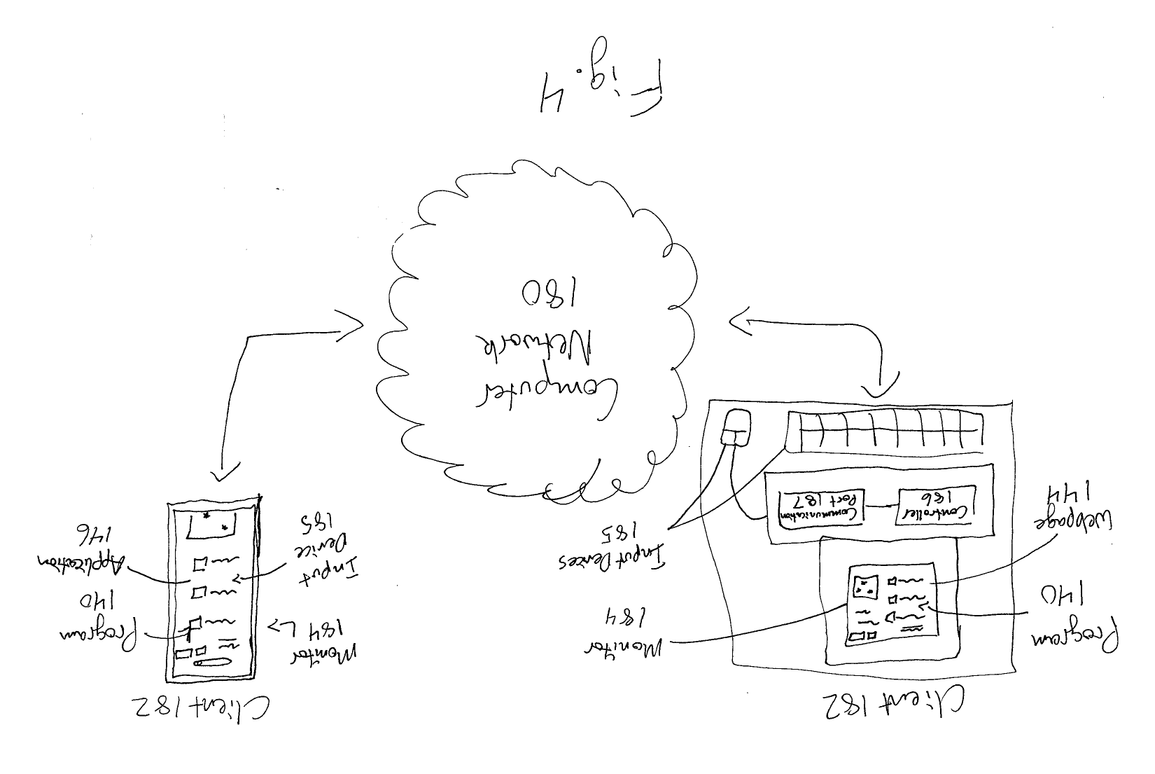

As mentioned earlier, the program 140 is preferably accessed through a computer network 180, the network 180 most preferably comprising a client 182 having a connection to the internet. As seen in FIG. 4, the client 182 most preferably comprises at least a monitor 184 (such as a computer screen, touchscreen, digital display, etc.), an input device 185 (such as a keyboard, mouse, touchscreen, etc.), and a controller 186 (e.g. a microprocessor) in electronic communication with a communication port 187. The communication port 187 may be wireless (e.g. a wi-fi receiver, a Bluetooth® receiver, etc.) or wired (e.g. a USB port of any kind). To access and use the program 140, a user preferably boots the program 140 on a client 182 (e.g. visits the program browser webpage 144 or loads the program application 146) and passes through the security checkpoint 154 by logging into their account 150 using the login credentials 152. The program 140 then loads and displays the GUI 142 on the monitor 184, which the user may manipulate using the input device 185.

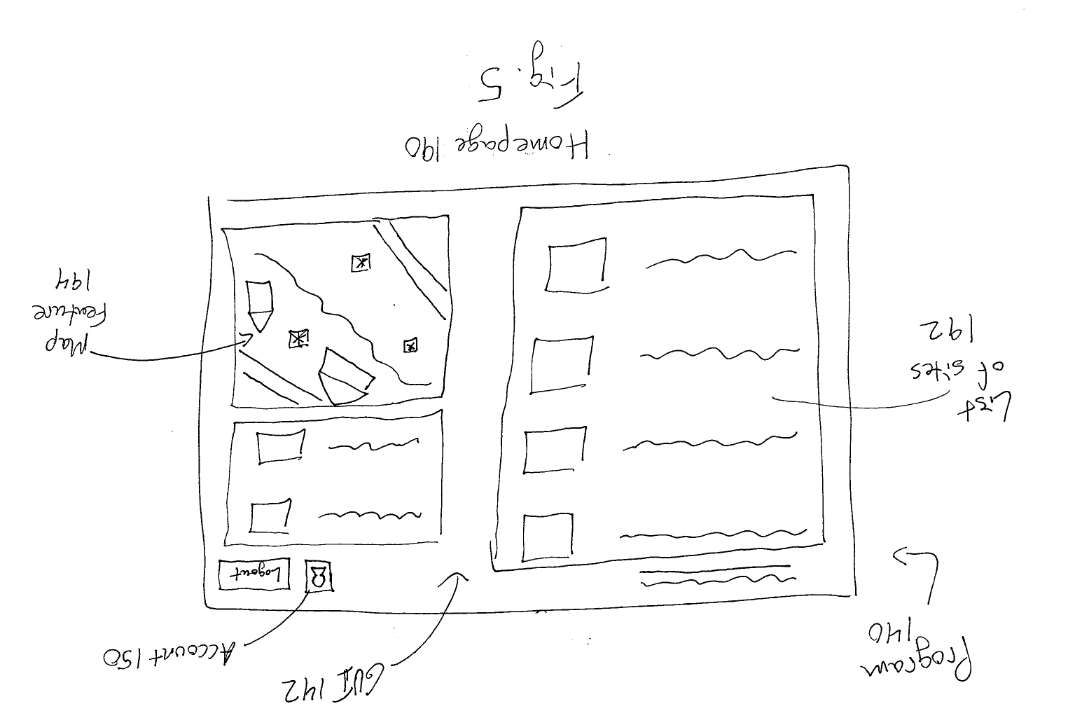

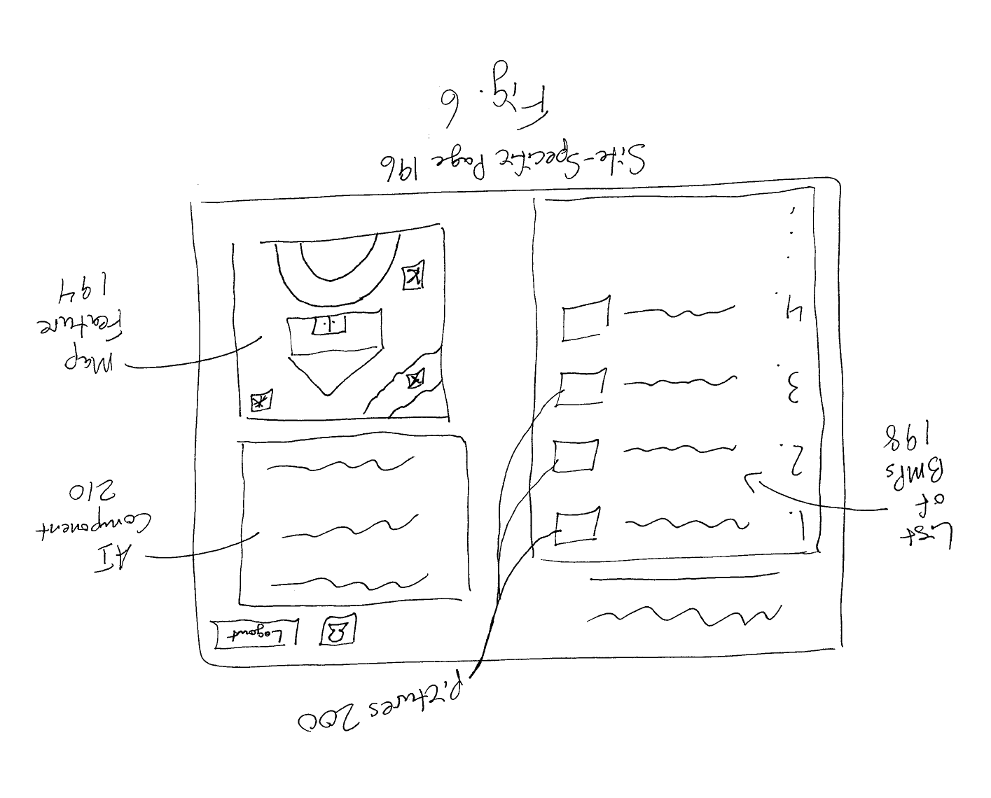

Most preferably, the program 140 first loads a homepage 190 displaying sites/locations for which BMP-related information 114 is available to the user’s account 150, including a list of the sites/locations 192 and preferably a map feature 194 displaying the location of the sites (e.g. an embedded Google Maps®), as seen in FIG. 5. Users may then select a site/location to be taken to a site-specific page 196 containing a list of BMP’s located at that site, as seen in FIG. 6. Selection may be made by clicking on the site/location name on the list of sites 192 or by clicking on the site on the embedded map feature 194. The site-specific page 196 preferably comprises all the BMP-related information 114 available on a given site, preferably organized such that all data related to one BMP are proximate or grouped together, preferably under or next to the BMP tracking number 132. For example, a typical layout may include BMP tracking numbers 132 in a BMP list 198, with all known BMP-related information 114 for that BMP displayed in a box next to the BMP tracking number 132, including the location 116 on the site, the type of BMP 118, structural features 120, and dates and/or details regarding construction 122, inspection 124, and maintenance 126 of that BMP, along with municipality reports on the BMP date and timestamped with the name of the person making the report 128 and the address of the site 130. Such information may be presented in any way, but may preferably be presented with a dropdown menu to filter and/or pick which information to see if not selecting an option to see all information for a BMP at once.

The site-specific page may further include a its own map feature 194, showing a map view of the specific site with the BMP locations 114 highlighted or otherwise distinguished from the surrounding area, along with the corresponding BMP tracking page number 132 for each BMP. Some embodiments of the present invention may further include a color coding or shading system, using different colors to distinguish the state of the BMP. For example, a color-coding system may highlight different BMP’s on the map feature 194 in blue if a known BMP is at that site address 130, but there is no other BMP-related information 114 available for the BMP. Other BMP locations 114 may be highlighted red if there is some action required at that BMP such as maintenance, repair, or full reconstruction, yellow if the BMP is ready or due for inspection, or green if the BMP is up to date on its inspection/maintenance needs. In another example, a shading system may be used for the same purposes, with a white filling representing that data is missing for a given BMP, hatching representing that inspection is required or due, cross-hatching representing that some action is required, and full shading representing that the BMP is up to date with its inspection/maintenance needs. The map feature 194 is preferably variable in scope, allowing a user to zoom out to general areas or in to specific sites. Most preferably, the map feature 194 even allows users to zoom into specific BMP’s themselves and shows components of that BMP along with pins related to that component linked to inspection/maintenance of that specific component. Such features offer an extremely quick way to intuitively and visually review BMP’s on both a macro and micro scale, giving users a full scope of the status of their sites.

Site specific pages also preferably comprise pictures 200 of each BMP on a site, if such pictures 200 are available. The pictures 200 may be arranged proximate the information 114 related to each BMP. One picture 200 may preferably show the BMP as it was on the date of construction being finalized and subsequent pictures 200 may be taken and uploaded to the program 140 on the date of each inspection and/or maintenance, both before and possibly after any work is completed.

The program 140 also preferably includes functionality to send notifications, whether within the program 140 or through other means like email, to users related to a specific site, such as a site owner, government employee, contractor, or the like, when one or more BMP’s or EC’s is in need of inspection or maintenance. Other reasons for notification may preferably include new construction possibly affecting existing BMP’s or EC’s, new rules or regulations passed by local, state, or the federal government related to BMP’s or EC’s that may affect existing structures.

Additionally, users are preferably able to send out notifications to other users regarding specific sites or even specific BMP’s/EC’s. For example, municipalities may be able to send reminder notifications to site owners and contractors related to a specific site. In another example, if a contractor is inspecting and/or performing maintenance on one or more of the BMP’s on a site, they may preferably be able to send notifications regarding the status of those inspections/maintenance to the site owner, other contractors, or other users related to the site. This ability to quickly and efficiently share information is paramount and drastically improves efficiency and clarity, both in the present and in the future.

Finally, many municipalities are starting to actually enforce reporting rules regarding BMP’s. Such reports, as explained above, often contain the same information collected on the database 110. Therefore, to improve efficiency, the program 140 preferably includes the ability to generate municipality reports 128 within the program 110 itself. Preferably, the custodian may keep examples of reports 128 from municipalities containing sites that have data on the database 110. Most preferably, those examples could then be used to create fillable reports within the program 140, with the option to hand-entered or auto-fill in the information 114 by the program 140.

In use, once BMP-related information 114 is collected (whether that be from municipal reports, site owners, or both), the database 110 is populated, and an account 150 is created on the program 140 and logged into, a user may manipulate the program 140 to review and/or update data related to BMP’s on a specific site that their account 140 has access to, including by adding and/or updating textual descriptions and picture of specific BMP’s. The system 100 may greatly improve efficiency and collaboration in BMP tracking and maintenance, providing a quick and simple way for site owners, overseers (such as government employees, and third-parties (such as contractors) to keep track of and share information, such as BMP locations and important dates. Access to the system 100 is extremely simple, any user having a client 182 (including a personal computer or handheld smart device) may access the program 140 through the internet by visiting the webpage 144 and/or possibly application 146. Further, with many municipalities beginning to enforce reporting rules, the system 100 greatly improves their ability to keep track of this information and possibly even fill out reports within the program 140 itself.

In one example, the site owner can pass along all known BMP-related information 114, whether that information was reported to a municipality or not, to the custodian, who populates the database 110 with the information 114 and creates the site-specific page 196 for the site owner. The custodian may even visit the site to collect information 114, such as pictures 200 of the BMP’s.

In another example, the site owner may login to their account 150 and view and/or update all of the information 114 that pertains to their site(s). If a contractor is hired by a site owner to inspect and/or provide maintenance work on the BMP’s located on a site, the contractor may create and/or log into their account 140 by pulling up the webpage 144 (or possibly application 146) and passing through the security checkpoint 154. The site owner, knowing that the contractor is coming to their site, may contact the custodian to allow the contractor access to the BMP-related information 114 available for their site or may allow the contractor access themselves through the program 140 and use the GUI 142 to allow the contractor access if they know the contractor’s account username or possibly account associated email. The contractor may then select the site on their homepage 190 and review the known BMP’s on that site on the site-specific page 196, including their descriptions, locations on the embedded map feature 194, any pictures taken of them, and their most recent inspection/maintenance dates. As the contractor performs their hired work, inspection and/or maintenance on one or more BMP’s on the site, the contractor can then update the BMP-related information 114 on the site-specific page 196 by adding descriptions of the work they did, timestamped and dated, along with picture(s) 200 of the worked on BMP, potentially even before and after the work is completed to show a complete history of the work being done. Importantly, the site owner is registered as an administrator over their own site specific page 196, granting them the ability to allow or deny access to other users at any time. Thus, if the site owner ever decides to hire a contractor, they can allow them access to their information. However, they can also may lock that contractor out back out at any time. This allows the site owner the freedom to build out a service network and make changes as they see fit by only sharing information with other users (individuals or organizations) as needed/wanted.

In yet another example, a government employee may be tasked with visiting one or multiple sites for BMP-related rules compliance and inspection. If a particular site owner has an account 150 on the system 100, they may simply give the government employee access (on their own through the system 100 or possibly by contacting the custodian) to all of their BMP-related information 114 to ensure the inspection goes as smoothly as possibly. Further, if the government employee or local government itself has an account 150, they may be granted access to limited information regarding all BMP’s in their jurisdiction. On top of saving time in looking for specific information or locations of certain BMP’s, such access could facilitate efficient planning of a government employee’s inspection process, such as by highlighting BMP locations to be inspected so that the employee may efficiently plan a travel route between each.

In future embodiments of the present invention, the system 100 may further include an artificial intelligence (AI) component 210 integrated into the program 140. For example, the AI component 210 could preferably analyze pictures 200 taken of a BMP for recognition and/or evaluation. That is, for site owners that are unaware of BMP specifics, the site owner may simply take a picture 200 of a BMP and upload it to their site-specific page 196 on the program 140. The AI component 210 may then analyze the picture 200 and generate BMP-related information 114 to populate the location specific section 112 of the database 110 related to that BMP, such as what type 118 of BMP it is, what structural features 120 the BMP consists of, and a general description of the BMP. Further, the AI component 210 may preferably have the ability to evaluate pictures 200 of the BMP and report structural problems that would require maintenance, such as blockages, overflows, and breakages. The AI component 210 may also preferably be used to view uploaded reports and other documents and create a list of BMP’s or other erosion control measures that need to be included in future inspections to streamline the setup process of a new site.

Additionally, the AI component 210 may be used to generate and populate stormwater BMP compliance reports, such as those submitted to municipalities discussed previously. The system 100 may preferably integrate the AI component 210, wherein a button or option in the system 100 allows the user to generate a blank report, then the AI component 210 can be engaged to review the information 112 and use it to populate the report. Additionally or alternatively, the AI component 210 may also be used to generate and populate other documents as well and may be able to access all information that the user, when logged into their specific profile, has access to, allowing the user to create reports containing information 112 related to several BMPs or even to BMPs at several different locations 114.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A method comprising the steps of:
storing a first set of information related to one or more stormwater best management practices (BMP's) in database accessible over the internet;
displaying the first set of information on a program accessible over the internet; and
manipulating the first set of information in real time,
wherein the first set of information comprises the address where the one or more stormwater BMPs are located, and
wherein the program further comprises an individual, separate webpage associated with each address containing stormwater BMPs, each webpage displaying the first set of information for the one or more BMPs located at its associated address.

2. The method of claim 1, wherein the manipulating step comprises
editing the database through each webpage of the program.

3. The method according to claim 1, wherein the first set of stored information comprises the particular location of each BMP at each address, the type of each BMP, the structural features of each BMP, inspection details related to each BMP, maintenance work details for each BMP, a tracking page
number for the webpage, municipality report details, and residential address details.

4. The method of claim 3, wherein manipulating step comprises generating a compliance report.

5. The method of claim 4, wherein the compliance report is automatically
populated using the first set of information.

6. The method of claim 1, wherein the first set of stored information comprises one or more full documents.

7. The method of claim 1, wherein the first set of stored information further comprises one or more pictures.

8. The method of claim 7, wherein the displaying further comprises simultaneously displaying on the webpage descriptive information of a BMP,
at least one picture of a BMP, and a location of the BMP on a map.

9. The method of claim 1, wherein the first set of stored information further comprises manipulable construction documents.

10. The method of claim 1, further comprising the steps of:
storing a second set of information related to one or more erosion
control measures (EC's) located at the same address as the first set of information related to the one or more BMPs; and
displaying the second set of information on the same webpage as the first set of information.

11. The method of claim 1, further comprising the steps of, before the
displaying step:
creating a profile; and
assigning to the profile access to only specific webpages on the program.

12. The method of claim 11, wherein profile comprises login credentials.

13. The method of claim 12, wherein the login credentials further comprise secondary security restrictions.

14. A method comprising the steps of:
storing a first set of information related to one or more stormwater best management practices (BMP's) in database accessible over the internet;
displaying the first set of information via an application on a smart device; and
manipulating the first set of information in real time,

15. The method of claim 14, wherein the stored information further comprises one or more full documents.

16. The method of claim 14, wherein the stored information further
comprises one or more pictures.

17. The method of claim 16, wherein the storing step comprises the steps of:
scanning a document using a camera of the smart device;
pulling relevant information from the scanned document; and uploading such relevant information to the database.

18. The method of claim 14, wherein the stored information further comprises manipulable construction documents.

19. The method of claim 14, further comprising the step of storing a second set of information related to one or more erosion control measures (EC's)
located at the same address as the first set of information related to the one or more BMPs.

20. The method of claim 14, further comprising the steps of, before the displaying step:creating a profile; and
assigning to the profile access to only specific sections in the application.
